(19) United States
(12) Patent Application Publication
(10) Pub. No.: US 2007/0279581 A1
(43) Pub. Date: Dec. 6, 2007

(54) BACKLIGHT MODULE FRAME

(75) Inventor: SHAO-HAN CHANG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/610,637

(22) Filed: Dec. 14, 2006

(30) Foreign Application Priority Data
Jun. 2, 2006 (CN) 200610060953.2

(51) Int. Cl. G02C 5/22

(52) U.S. Cl. 351/153

(57) ABSTRACT

An exemplary frame (100) includes a number of frame extensions (11), a number of side-frames (13), a number of extension holders (16), and a number of fastening members (17). The side-frames are arranged alternately with the frame extensions such that the side-frames and the frame extensions abut each other end-to-end. The extension holders are positioned where the side-frames and the frame extensions abut each other. The fastening members attach the extension holders to the abutted frame extensions and side-frames so as to fasten the abutted frame extensions and side-frames together.

### BACKGROUND OF THE INVENTION

1. Field of the Invention

The present invention generally relates to a backlight module frame typically used in a liquid crystal display device.

2. Discussion of the Related Art

A typical liquid crystal display device comprises a liquid crystal display panel, and a backlight module mounted under the liquid crystal display panel. The backlight module supplies light to the liquid crystal display panel, and mainly comprises a light source, a light guide plate, and a frame. The light guide plate is made of a transparent acrylic plastic. The light guide plate is used for guiding light received from the light source, and thus uniformly illuminating the liquid crystal display panel. The frame is usually made of metal, and is used for providing high mechanical strength that protects the light guide plate and the light source.

Referring to FIG. 6, a typical frame 10 is shown. The frame 10 is substantially rectangular in shape. The frame 10 is integrally manufactured as a single piece by punching a metal sheet. A middle portion of the metal sheet is cut out to house other optical elements. However, this is disadvantageous because the leftover portion of the metal sheet cut out is not used and is wasted. That is, the leftover portion is too small and cannot be used for punching smaller frames. Unused, wasted leftover portions increase the cost of production. In addition, if the frame is large, a larger punch is required, a larger leftover portion is wasted, and the cost of production is correspondingly higher.

Referring to FIG. 7, another kind of frame 20 includes two frame extensions 201 and two side-frames 203. Each of the frame extensions 201 and the side-frames 203 may be produced by punching a single piece of metal sheet. Each of the frame extensions 201 is substantially an elongated flat thin sheet with a rim perpendicularly extending along an outer edge. Each of the side-frames 203 is also substantially a flat thin sheet with a rim perpendicularly extending along an outer edge. Each side-frame 203 forms two corresponding corners of the frame 20, and has a generally C-shaped structure. Referring also to FIG. 8, one of the side-frames 203 is fastened with the frame extensions 201 by welding. In the same way, the other side-frame 203 is fastened with the frame extensions 201 by welding to form a single body.

In the above-described frame 20, a welding surface 205 where each frame extension 201 adjoins each side-frame 203 is small, because each frame extension 201 and each side-frame 203 is a thin sheet. Thus, a strength of each joint between the frame extension 201 and the side-frame 203 is weak. In addition, if the frame 20 is subjected to stress, the stress is liable to accumulate in and around each welding surface 205. When this happens, the frame 20 may easily deform.

Therefore, a new frame is desired in order to overcome the above-described shortcomings.

### SUMMARY

A frame includes a number of frame extensions, a number of side-frames, a number of extension holders, and a number of fastening members. The side-frames are arranged alternately with the frame extensions such that the side-frames and the frame extensions abut each other end-to-end. The extension holders are positioned where the side-frames and the frame extensions abut each other. The fastening members attach the extension holders to the abutted frame extensions and side-frames so as to fasten the abutted frame extensions and side-frames together.

Another frame includes a number of frame extensions, a number of side-frames, and a number of extension holders. The side-frames are arranged alternately with the frame extensions such that the side-frames and the frame extensions abut each other end-to-end. The extension holders are positioned where the side-frames and the frame extensions abut each other. Each extension holder is attached to the corresponding abutting frame extension and side-frame by welding so as to fasten the corresponding abutting frame extension and side-frame together.

Other novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present frame. Moreover, in the drawings, like reference numerals designate corresponding parts throughout the several views, and all the views are schematic.

FIG. 1 is an isometric view of a frame in accordance with a first embodiment of the present invention.

FIG. 2 is an enlarged view of a circled portion 11 of FIG. 1.

FIG. 3 is an isometric view of part of a frame in accordance with a second embodiment of the present invention.

FIG. 4 is an isometric view of part of a frame in accordance with a third embodiment of the present invention.

FIG. 5 is an isometric view of part of a frame in accordance with a fourth embodiment of the present invention.

FIG. 6 is an isometric view of a conventional frame.

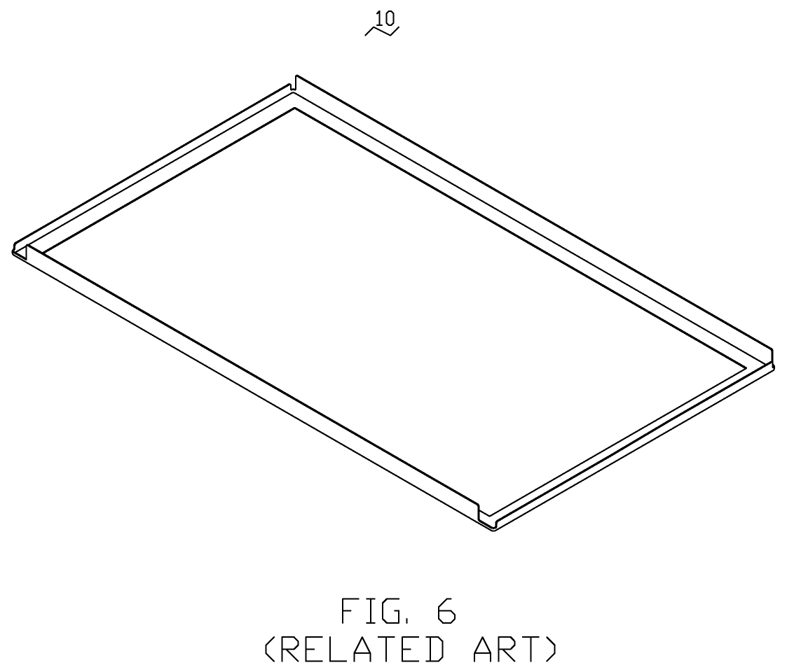

FIG. 7 is an isometric view of another conventional frame, showing the frame partly assembled.

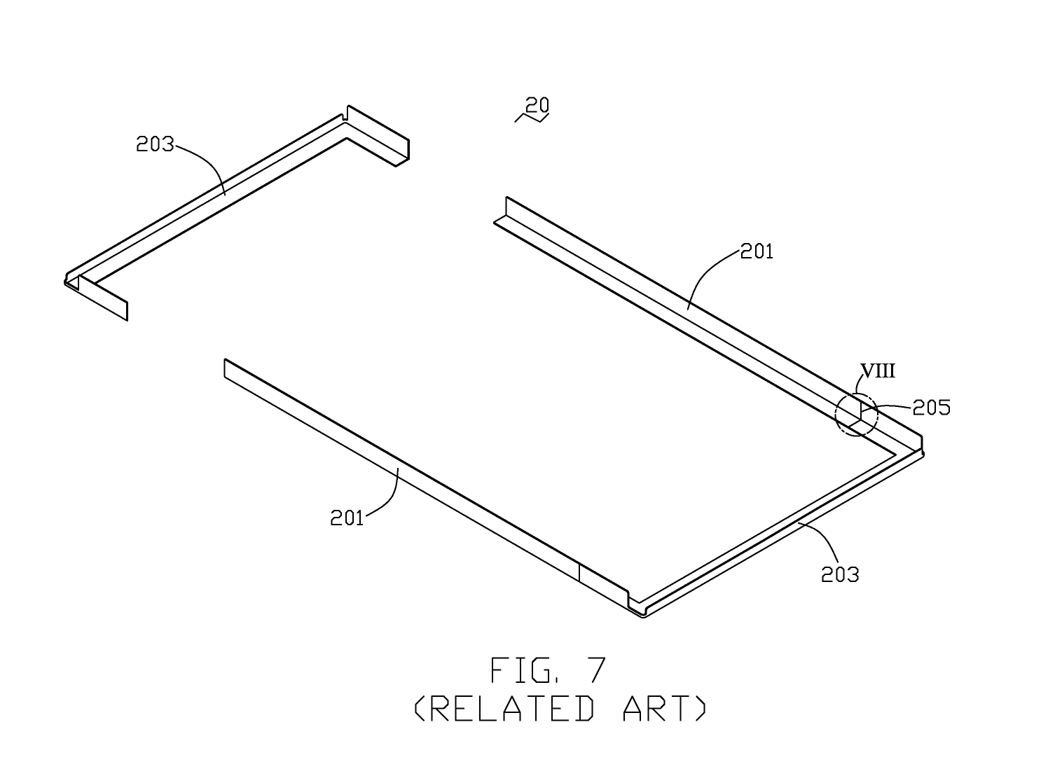

FIG. 8 is an enlarged view of a circled portion VII of FIG. 7.

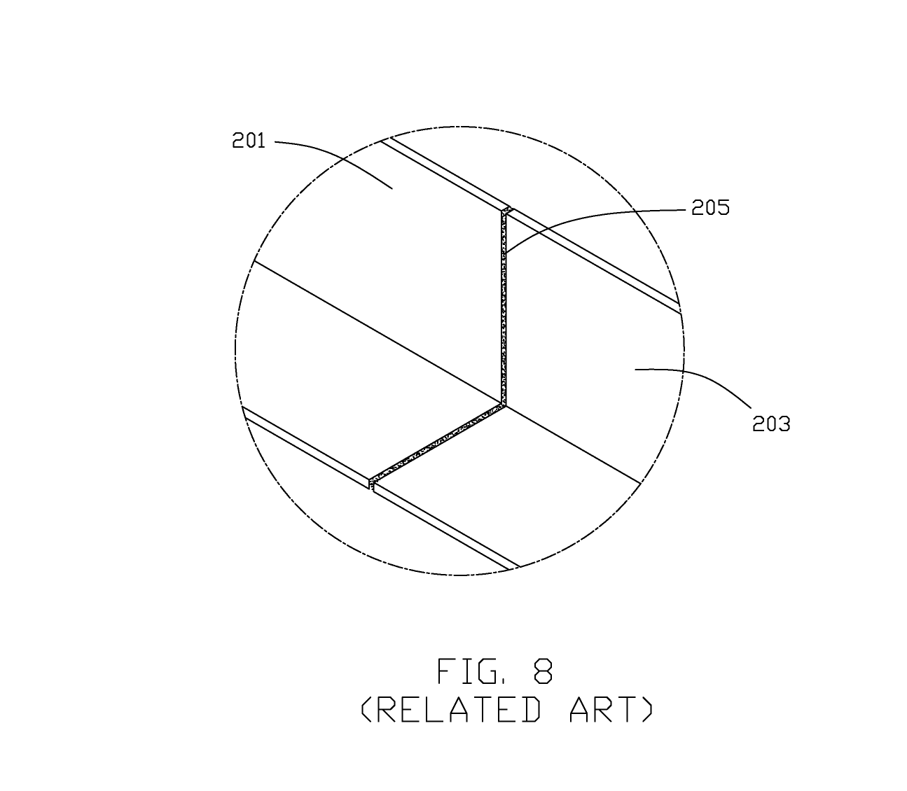

### DETAILED DESCRIPTION OF THE EMBODIMENTS

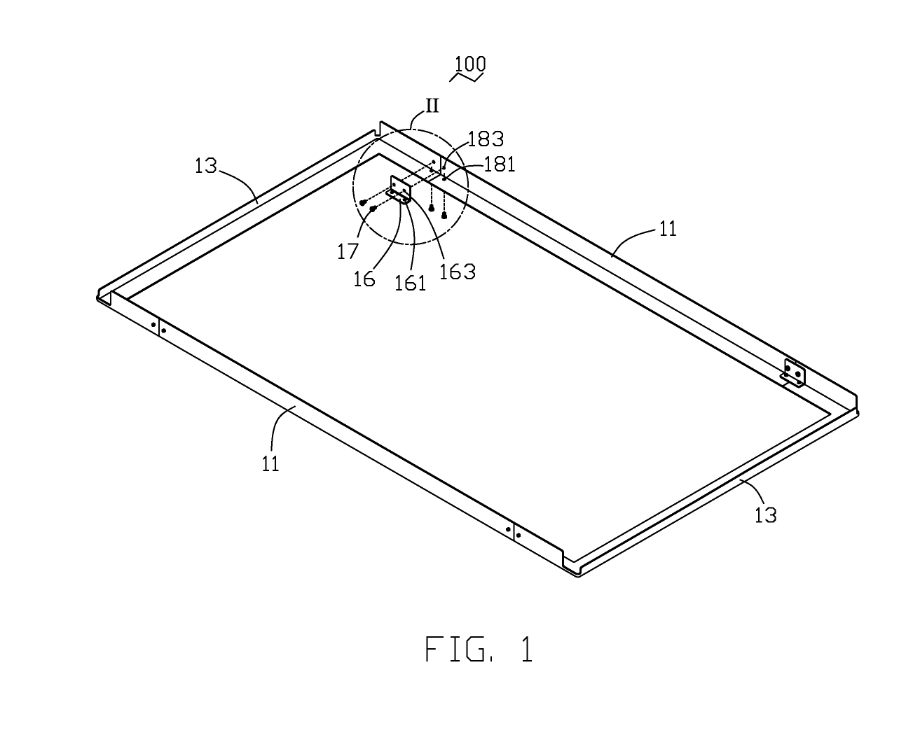

Referring now to the drawings in detail, FIG. 1 shows a frame 100 for a backlight module according to a first preferred embodiment. The frame 100 includes two frame extensions 11, two side-frames 13, four extension holders 16, and sixteen fastening members 17. The frame extensions 11, the side-frames 13, and the extension holders 16 may be produced together by punching a single piece of metal sheet.

Each of the frame extensions 11 is substantially an elongated flat thin sheet with a rim perpendicularly extending along an outer edge. A frame through hole 181 is defined at each end of the frame extensions 11, and a rim through hole 183 is defined at each end of the rims. In the preferred embodiment, each of the rim through holes 183 is threaded. The frame extensions 11 are configured to be symmetrical to each other.

Each of the side-frames 13 is substantially a flat thin sheet with a rim perpendicularly extending along an outer edge. Each of the side-frames 13 forms two corresponding corners of the frame 100, and has a generally C-shaped structure. A frame through hole 181 is defined at each end of the side-frames 13, and a rim through hole 183 is defined at each end of the rims. In the preferred embodiment, each of the rim through holes 183 is threaded. The side-frames 13 are configured to be symmetrical to each other.

The material of the extension holder 16 can be selected from the group consisting of galvanized steel, stainless steel, aluminum, copper, and any suitable alloy thereof. A shape of each extension holder 16 corresponds to either of the frame extension 11 and the side-frame 13. Each of the extension holders 16 is substantially a flat thin sheet with a rim perpendicularly extending along an outer edge. Each extension holder 16 defines a pair of holder through holes 161, and a pair of rim through holes 163. In the preferred embodiment, each of the holder through holes 161 is threaded. A shape of the holder through holes 161 of each extension holder 16 corresponds to the frame through hole 181. A shape of the rim through holes 163 corresponds to the rim through holes 183.

Each fastening member 17 is typically a screw. One of the fastening members 17 is configured for engaging in one of the rim through holes 163 of the extension holder 16 and the rim through hole 183 of the frame extension 11 correspondingly. Another one of the fastening members 17 is configured for engaging in the other rim through hole 163 of the extension holder 16 and the rim through hole 183 of the side-frame 13 correspondingly. A further one of the fastening members 17 is configured for engaging in the frame through hole 181 of the frame extension 11 and one of the holder through holes 161 of the extension holder 16 correspondingly. A still further one of the fastening members 17 is configured for engaging in the frame through hole 181 of the side-frame 13 and the other holder through hole 161 of the extension holder 16 correspondingly. Thus, the extension holder 16 is attached to the abutted frame extension 11 and the side-frame 13, so as to fasten the frame extension 11 and the side-frame 13 together.

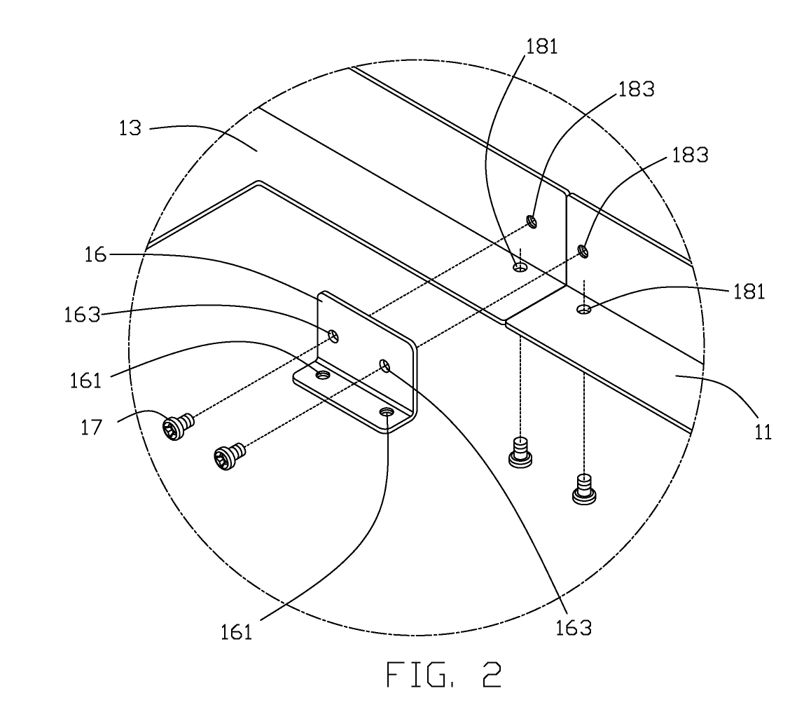

Referring also to FIG. 2, in assembly, a first end of one of the frame extensions 11 abuts against a first end of one of the side-frames 13. The rim through holes 163 of one of the extension holders 16 align with the rim through holes 183 of the frame extension 11 and of the side-frame 13 correspondingly. The holder through holes 161 of one of the extension holders 16 align with the frame through holes 181 of the frame extension 11 and of the side-frame 13 correspondingly. One fastening member 17 passes through one of the rim through holes 163 of the extension holder 16, and is screwed into the rim through hole 183 of the frame extension 11 correspondingly. Another fastening member 17 passes through the other rim through hole 163 of the extension holder 16, and is screwed into the rim through hole 183 of the side-frame 13 correspondingly. A further fastening member 17 passes through the frame through hole 181 of the frame extension 11, and is screwed into one of the holder through holes 161 of the extension holder 16 correspondingly. A still further fastening member 17 passes through the frame through hole 181 of the side-frame 13, and is screwed into the other holder through hole 161 of the extension holder 16 correspondingly. The frame extension 11 and the side-frame 13 are thus fastened into position via the extension holder 16. In the same way, the frame extension 11 and the other side-frame 13 are fastened into position via another one of the extension holders 16. Likewise, the other frame extension 11 and the side-frames 13 are fastened into position via the other extension holders 16. Thus, the frame 100 is assembled into a whole.

In the frame 100, abutted frame extensions 11 and the side-frames 13 are fastened by extension holders 16 and fastening members 17. The extension holders 16 increase an interactional surface when the frame extensions 11 are fastened with the side-frames 13, therefore increasing strengths of the joints where the frame extensions 11 and the side-frames 13 are fastened together. In addition, the extension holders 16 distribute the stress to the interactional surfaces of the two frame extensions 11 and the side-frames 13 when the frame 100 is subjected to stress, thereby reducing the stress of the joints where the frame extensions 11 and the side-frames 13 are fastened together. This avoids deformation of the frame 100.

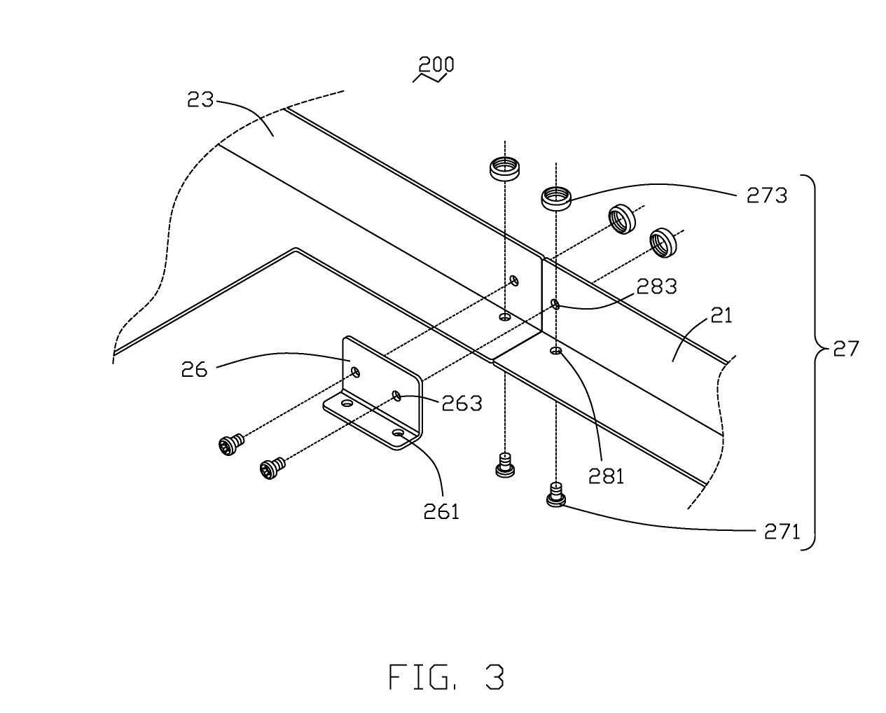

Referring to FIG. 3, a frame 200 according to a second embodiment is shown. The frame 200 is similar in principle to the frame 100 described previously, except that each of the fastening members 27 consists of a screw 271 and a screw cap 273 that is configured to engage with the screw 271. Each of extension holders 26 defines a pairs of holder through holes 261, and a rim of the extension holder 26 defines a pair of rim through holes 263. Each end of frame extensions 21 and each end of side-frames 23 defines a frame through hole 281 and a rim through hole 283. A first screw 271 passes through one of the rim through holes 263 of the extension holder 26 and the rim through hole 283 of the frame extension 21 correspondingly, and is engaged with a first screw cap 273. A second screw 271 passes through the other rim through hole 263 of the extension holder 26 and the rim through hole 283 of the side-frame 23 correspondingly, and is engaged with a second screw cap 273. A third screw 271 passes through the frame through hole 281 of the frame extension 21 and one of the holder through holes 261 of the extension holder 26 correspondingly, and is engaged with a third screw cap 273. A fourth screw 271 passes through the frame through hole 281 of the side-frame 23 and the other holder through hole 261 of the extension holder 26 correspondingly, and is engaged with a fourth screw cap 273. The frame extensions 21 and the side-frames 23 are thus fastened into position via the extension holders 26.

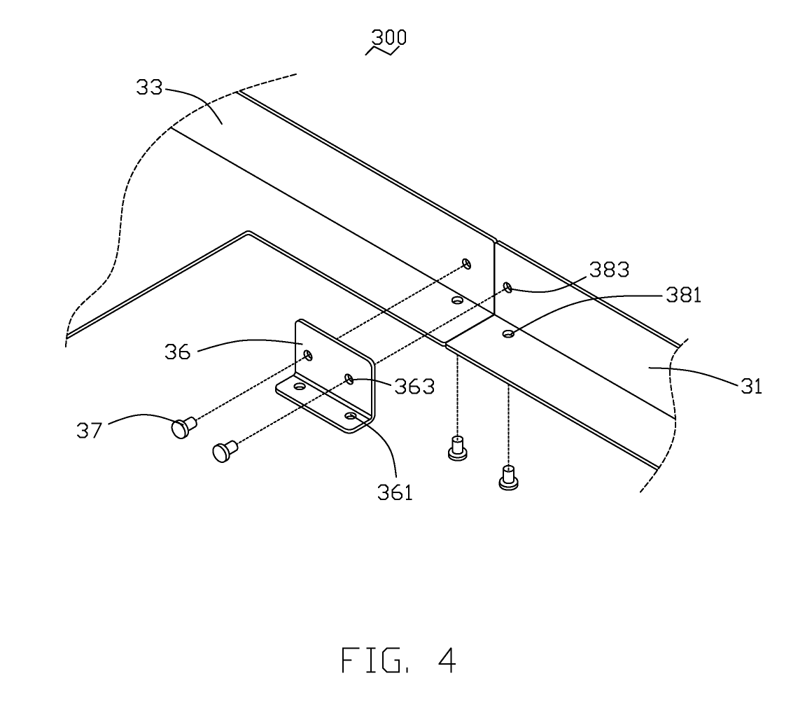

Referring to FIG. 4, a frame 300 according to a third embodiment is shown. Each of extension holders 36 defines a pairs of holder through holes 361, and a rim of the extension holder 36 defines a pair of rim through holes 363. Each end of frame extensions 31 and each end of side-frames 33 defines a frame through hole 381 and a rim through hole 383. The frame 300 is similar in principle to the frame 200 described previously, except that each fastening member 37 is a rivet. Each fastening member 37 is engaged with one of the through holes 361/363 of the extension holder 36, and the through hole 381/383 of the frame extension 31 or the side-frame 33 correspondingly. Thus, the frame extensions 31 and the side-frames 33 are fastened into position via the extension holders 36.

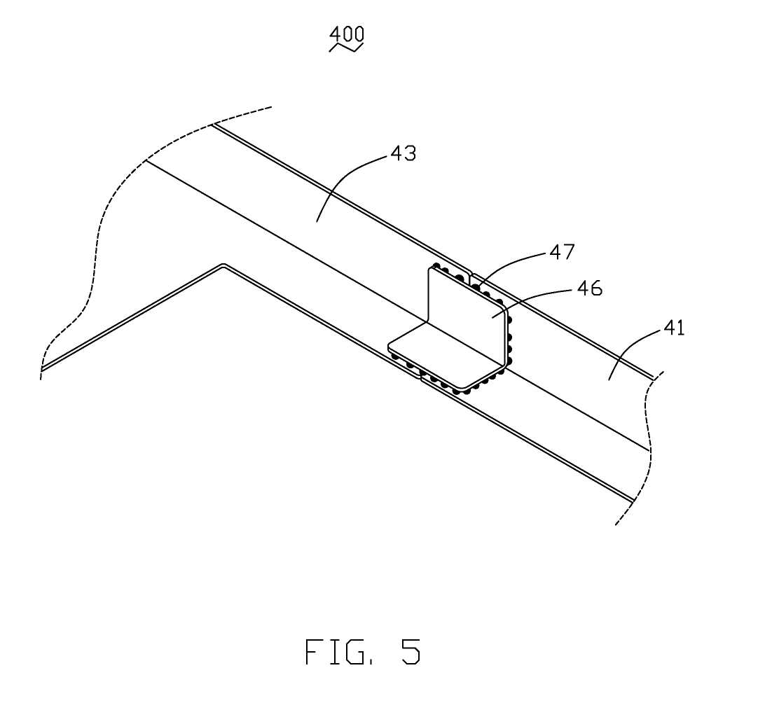

Referring to FIG. 5, a frame 400 according to a third embodiment is shown. The frame 400 is similar in principle to the frame 100 described previously, except that each extension holder 46 includes a plurality of welding spots 47. The extension holder 46 is attached to the corresponding abutted frame extension 41 and side-frame 43 by welding, such that the frame extension 41 and the side-frame 43 are fastened together.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A frame, comprising:
a plurality of frame extensions;
a plurality of side-frames, the side-frames being arranged alternately with the frame extensions such that the side-frames and the frame extensions abut each other end-to-end;
a plurality of extension holders positioned where the side-frames and the frame extensions abut each other; and
a plurality of fastening members, the fastening members attaching the extension holders to the abutted frame extensions and side-frames so as to fasten the abutted frame extensions and side-frames together.

2. The frame as claimed in claim 1, wherein a shape of each extension holder corresponds to either of the frame extension and the side-frame.

3. The frame as claimed in claim 2, wherein each of the frame extensions is an elongated flat thin sheet with a rim extending along an outer edge.

4. The frame as claimed in claim 2, wherein each of the extension holders is a flat thin sheet with a rim extending along an outer edge.

5. The frame as claimed in claim 2, wherein each fastening member is a screw, each of the frame extensions and the extension holders defines a plurality of locking holes, the screw is engaged in the locking holes of the frame extension and the extension holder to attach the extension holder to the frame extension.

6. The frame as claimed in claim 2, wherein each fastening member is a screw, each of the side-frames and the extension holders defines a plurality of locking holes, the screw is engaged in the locking holes of the side-frame and the extension holder to attach the extension holder to the side-frame.

7. The frame as claimed in claim 2, wherein each end of the frame extensions defines a frame through hole, each extension holder defines a pair of holder through holes, the holder through holes are threaded, the fastening member is engaged in the frame through hole of the frame extension and the holder through hole of the extension holder.

8. The frame as claimed in claim 2, wherein each end of the side-frames defines a frame through hole, each extension holder defines a pair of holder through holes, the holder through holes are threaded, the fastening member is engaged in the frame through hole of the side-frame extension and the holder through hole of the extension holder.

9. The frame as claimed in claim 2, wherein each end of the frame extensions defines a rim through hole, the rim through holes of the frame extensions are threaded, each extension holder defines a pair of rim through holes, the fastening member is engaged in the rim through hole of the extension holder and the rim through hole of the frame extension.

10. The frame as claimed in claim 2, wherein each end of the side-frames defines a rim through hole, the rim through holes of the side-frames are threaded, each extension holder defines a pair of rim through holes, the fastening member is engaged in the rim through hole of the extension holder and the rim through hole of the side-frame.

11. The frame as claimed in claim 2, wherein each fastening member consists of a screw and a screw cap, each of the frame extensions, the side-frames and the extension holders defines a plurality of locking holes, the screw passes through the locking holes of the extension holder, and one of the frame extension and the side-frame, and is engaged with the screw cap to attach the extension holder to the frame extension and the side-frame.

12. The frame as claimed in claim 1, wherein each locking hole is a through hole, each end of the frame extensions and the side-frames defines a frame through hole and a rim through hole, each extension holder defines a pair of holder through holes and a pair of rim through holes.

13. The frame as claimed in claim 2, wherein each fastening member is a rivet, each of the frame extensions, the side-frames and the extension holders define a plurality of locking holes, the rivet is engaged with the locking holes of the extension holder, and one of the frame extension and the side-frame to attach the extension holder to the frame extension and the side-frame.

14. The frame as claimed in claim 13, wherein each locking hole is a through hole, each end of the frame extensions and the side-frames defines a frame through hole and a rim through hole, each extension holder defines a pair of holder through holes and a pair of rim through holes.

15. The frame as claimed in claim 1, wherein each frame extension is made of metal material.

16. The frame as claimed in claim 1, wherein each side-frame forms two corresponding corners of the frame and has a generally C-shaped structure, and is a flat thin metal sheet with a rim extending along an outer edge.

17. The frame as claimed in claim 1, wherein each extension holder is made of metal material.

18. The frame as claimed in claim 17, wherein the metal material of the extension holder is selected from the group consisting of galvanized steel, stainless steel, aluminum, copper, and any alloy thereof.

19. A frame, comprising:
a plurality of frame extensions;
a plurality of side-frames, the side-frames being arranged alternately with the frame extensions such that the side-frames and the frame extensions abut each other end-to-end; and
a plurality of extension holders positioned where the side-frames and the frame extensions abut each other, each extension holder attached to the corresponding abutting frame extension and side-frame by welding so as to fasten the corresponding abutting frame extension and side-frame together.
